(19) United States
(12) Patent Application Publication
(10) Pub. No.: US 2026/0208388 A1
(43) Pub. Date: Jul. 23, 2026

(54) Apparatus for Splicing Lumber

(71) Applicant: Superior Trusses, LLC, Lititz, PA (US)

(72) Inventor: Ernest Z. Eby, Ephrata, PA (US)

(73) Assignee: Superior Trusses, LLC, Lititz, PA (US)

(21) Appl. No.: 19/033,168

(22) Filed: Jan. 21, 2025

(51) Int. Cl. B27F 7/15

(52) U.S. Cl. CPC B27F 7/155

(57) ABSTRACT

A lumber splicing machine includes a pair of opposing movable jaws pivotally connected by a pivot linkage with a linear actuator for the application of opposing nailer plates opposite sides of the pieces of lumber to be co-joined. The nailer plates rest on spring-loaded support bars that are located below the jaws and recess as the tips of the support bars engage the sides of the tray. The motion of each of the movable plate is about a fixed pivot positioned below a tray supporting the pieces of lumber to be spliced together, such that the lower portion of each nailer plate first engages the lumber at a corresponding lower portion thereof, and progressively closes vertically until the movable jaws reach a closed position such that the lumber is urged downwardly against the support tray and keeps the gap between the pieces of lumber closed.

### FIELD OF THE INVENTION

The present invention generally relates to devices for splicing lumber and, more particularly, to an apparatus that connects lumber members in an end-to-end manner to create longer lumber members for use in the manufacturing of trusses.

### BACKGROUND OF THE INVENTION

Residential, and some commercial, structures are built with roof trusses that are manufactured at a remote location and transported to the construction site for the structure being built. The roof trusses are typically placed on top of building structure by a crane to form the roof for the structure being built. Each truss is formed with a horizontal base member and two opposing upper sloped members joined together at the roof peak and to the base member at the opposing ends thereof. Diagonally oriented cross members extending between the upper sloped members and the base member distribute the loads carried by the truss so that the truss can be manufactured using 2×4 lumber members, thereby reducing costs of manufacture.

Depending on the size of the structure being built, the base member, and even the upper sloped members, can require a lumber member that has a length dimension that typically is longer than lumber can be purchased, or at the very least at a cost that is cost effective in the manufacture of trusses. To remedy this problem, devices have been created to splice two lumber members in an end-to-end manner to create the requisite length of lumber member. This splice is formed by positioning the two lumber members end-to-end and connecting the lumber members by a nailing plate overlapping both lumber members on both opposing sides of the joint. The formation of this joint between two discrete lumber members, for example a twelve-foot long 2×4 board can be spliced to an eight-foot long 2×4 board to create a twenty-foot long 2×4 for use in the construction of a roof truss.

One such splicing machine is manufactured by MiTek, Inc. of Minneapolis, MN and by Fitzgerald Group, LLC of Colorado Springs, CO. These machines are similar in nature in that they press the nailer plates onto the two lumber members to be spliced together by a first pair of opposing rollers that simultaneously engage opposite sides of the lumber members and push the nailer plates into engagement with the lumber members from one lateral end of the nailer plates to the other. A second pair of opposing rollers engages the trailing lumber member and conveys the trailing lumber member with the preceding lumber member. One problem with this spicing machine configuration is that a gap is often created between the preceding and trailing lumber members as the nailer plate is pressed into the lumber members by the first pair of opposing rollers. This gap is known to be as large as about a quarter of an inch and is not a desirable feature for the base member of a roof truss.

A different configuration of a splicing machine is manufactured by MiTek, Inc. as the FT Splicer™. This splicing machine is also shown in U.S. Pat. No. 6,907,820 granted to Kathy LiuHui Jin, et al, on Jun. 21, 2005. The operation of a splicer machine includes a hydraulic press that engages the whole nailer plates in order to push the nailer plates into the two lumber members being spliced together. This configuration of splicing machine can be vertically oriented, as represented in the aforementioned '820 patent, or horizontally to provide a more user-friendly apparatus. In operation, this configuration of a splicing machine can have the nailer plates retained by a magnetic holder while the lumber members are positioned appropriately for splicing. One disadvantage of this splicing machine configuration is the cycle time between splicing operations and the potential movement of the nailer plates and the lumber members as the nailer plates are pressed into the lumber members.

It would be desirable to provide a splicing machine for joining two lumber members with nailer plates pressed into the co-joined lumber members that has an improved cycle time and does not laterally convey the lumber members as the nailer plates are pressed into the lumber members to splice them together.

### SUMMARY OF THE INVENTION

It is an object of this invention to overcome the disadvantages of the prior art by providing a lumber splicer apparatus connecting two pieces of lumber with opposing nailer plates.

It is another object of this invention to co-join lumber pieces to form a larger piece of lumber by installing nailer plates that will secure the two smaller pieces of lumber together.

It is an advantage of this invention that the cycle time for use of the lumber splicer is improved over the processes of known splicers.

It is a feature of this invention that the installation of nailer plates into the lumber pieces to be joined together does not force lateral movement of one lumber piece relative to the lumber piece to be joined thereto.

It is another feature of this invention that the movement of the jaws bearing the nailer plates can be actuated by a single hydraulic or pneumatic actuator.

It is another advantage of this invention that the nailer plates are started at the bottom thereof into engagement with the lumber members with the continued progression of the engagement moving upwardly along the lumber members as the movable jaws move toward the closed position.

It is still another advantage of this invention that the initial engagement of the nailer plates with the bottom of the lumber member, and thereafter progressing toward the top of the lumber members, draws the lumber members downwardly against the base member of the tray.

It is yet another object of this invention to keep the lumber members together at the joint therebetween, overlapped by the opposing nailer plates.

It is still another feature of this invention that support bars project from below the movable jaws on which the nailer plates can rest when the splicing machine is in an opened position.

It is yet another advantage of this invention that the support bars engage the sides of the tray as the jaws are being pivoted into the closed position to cause the support bars to retract beneath the movable jaws.

It is yet another feature of this invention that the support bars are spring-loaded so that the support bars return to a position projecting inwardly of the movable jaws to support a loading of nailer plates when the splicing machine is in an opened position.

It is a further feature of this invention that the operation of the splicing machine is controlled by actuation levers mounted on the upper surface of the machine on opposing sides of the movable jaws.

It is a further advantage of this invention that both actuation levers must be depressed to affect movement of the jaws from the opened position to a closed position.

It is still a further feature of this invention that the release of one of the actuation levers, while the other actuation lever is still depressed will result in the cessation of movement of the jaws applying nailer plates to the lumber members to be co-joined.

It is still a further advantage of this invention that the release of both actuation levers will result in the retraction of the linear actuator and the return of the movable jaws into the opened position.

It is yet a further feature of this invention that the splicing machine includes a kill switch that is engageable with the head of the extendable rod of the linear actuator such that the hydraulic system is disabled when the splicing machine is placed into the opened position, which can be reactivated by the depression of both actuator levers.

It is still another object of this invention to provide a lumber splicing machine which is durable in construction, requires limited maintenance, and is simple to operate and effective in use.

These and other objects, features and advantages are accomplished according to the instant invention by providing a lumber splicing machine that includes a pair of opposing movable jaws pivotally connected with a linear actuator for the application of opposing nailer plates to a joint between two individual pieces of lumber. Each movable jaw is provided with a nailer plate to apply to the opposite sides of the pieces of lumber to be co-joined. The nailer plates rest on spring-loaded support bars that are located below the jaws and recess as the tips of the support bars engage the sides of the tray. The motion of each of the movable plates is about a fixed pivot that is positioned below the tray supporting the pieces of lumber to be spliced together, such that the lower portion of each nailer plate first engages the lumber at a corresponding lower portion thereof, and progressively closes vertically on the lumber until the movable jaws reach a closed position. This splicing motion pulls the lumber downwardly against the support tray and keeps the joint between the pieces of lumber closed.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a perspective view of a splicing machine incorporating the principles of the instant invention, the movable jaws being placed in an open position to receive nailer plates and lumber members to be spliced together;

FIG. 2 is a perspective view of the splicing machine shown in FIG. 1 but with frame and cover members removed to provide a better view of the operative components of the splicing machine;

FIG. 3 is a perspective view of the cycling machine as shown in FIG. 2, but with the movable jaws being moved to a closed position that presses the nailer plates into the two lumber members being spliced together;

FIG. 4 is an elevational view of the operative components with the movable jaws being moved to the closed position as shown in FIG. 3;

FIG. 5 is an enlarged elevational view of the pivot linkage interconnecting the linear actuator and the movable jaws to affect movement of the movable jaws, the movable jaws being in the closed position as depicted in FIG. 4;

FIG. 6 is an enlarged elevational view of the pivot linkage as shown in FIG. 5, but with the movable jaws in the opened position as depicted in FIG. 1;

FIG. 7 is a top plan view of the splicing machine with the movable jaws in the opened position;

FIG. 8 is a top plan view of the splicing machine with the movable jaws in the closed position;

FIG. 9 is a perspective view of a portion of the obverse side of the spicing machine;

FIG. 10 is a perspective view of a movable jaw from the splicing machine to show the bulges in the center of the movable jaws;

FIG. 11 is a top plan detail view of one of the movable jaws to show the bulge in the center of the movable jaw;

FIG. 12 is a perspective operation diagram of the obverse side of the splicing machine reflecting the placement of the two lumber members onto the splicing machine;

FIG. 13 is a perspective operation diagram of the obverse side of the splicing machine reflecting the insertion of the nailer plates onto the opposing movable jaws;

FIG. 14 is a perspective operation diagram of the obverse side of the splicing machine reflecting the engagement of the electric switch triggers;

FIG. 15 is a perspective operation diagram of the obverse side of the splicing machine reflecting the pressing of the nailer plates into the two lumber members; and

FIG. 16 is a perspective operation diagram of the obverse side of the splicing machine reflecting the removal of the spliced lumber member from the splicing machine to complete the operational cycle.

### DETAILED DESCRIPTION OF THE PREFERRED EMBODIMENT

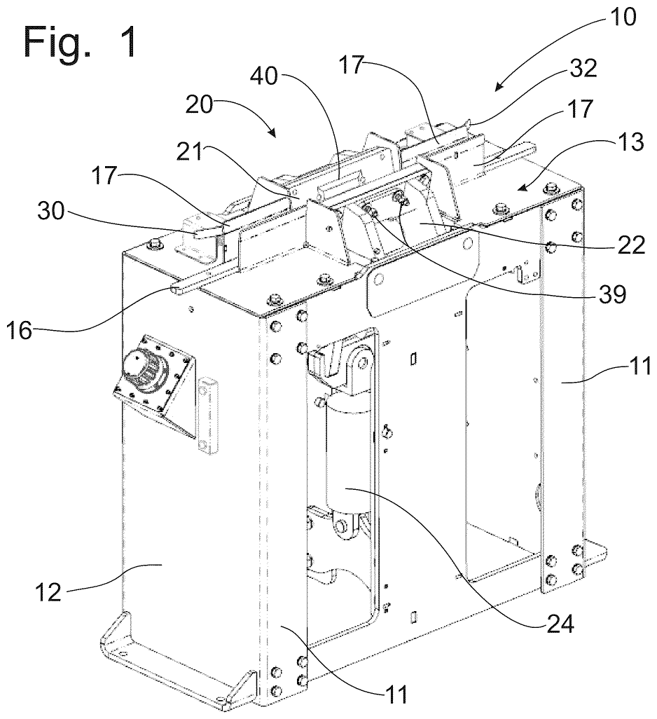

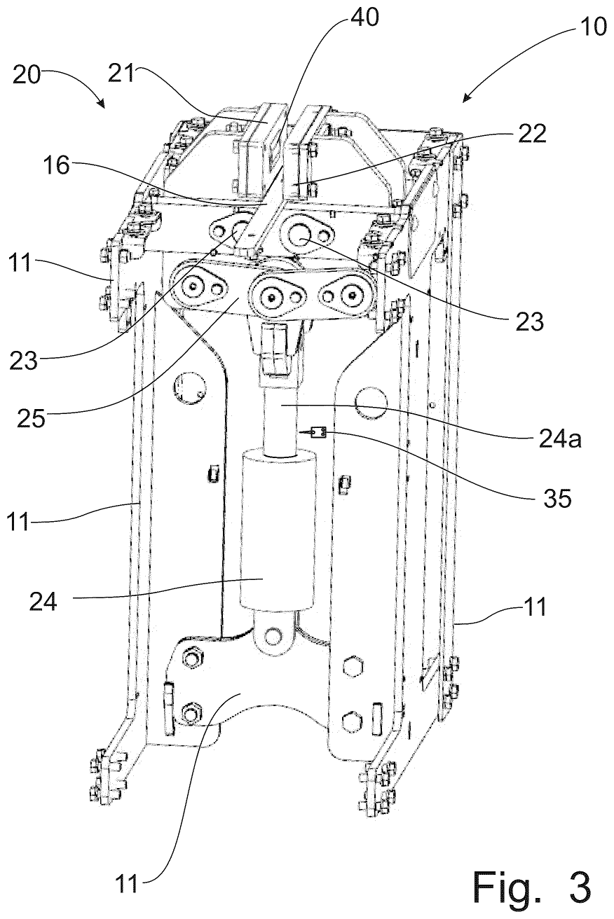

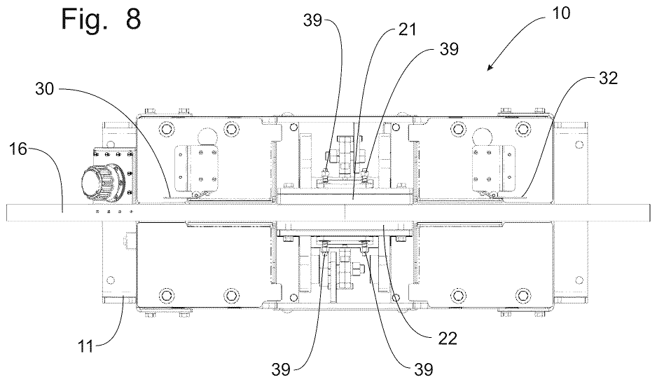

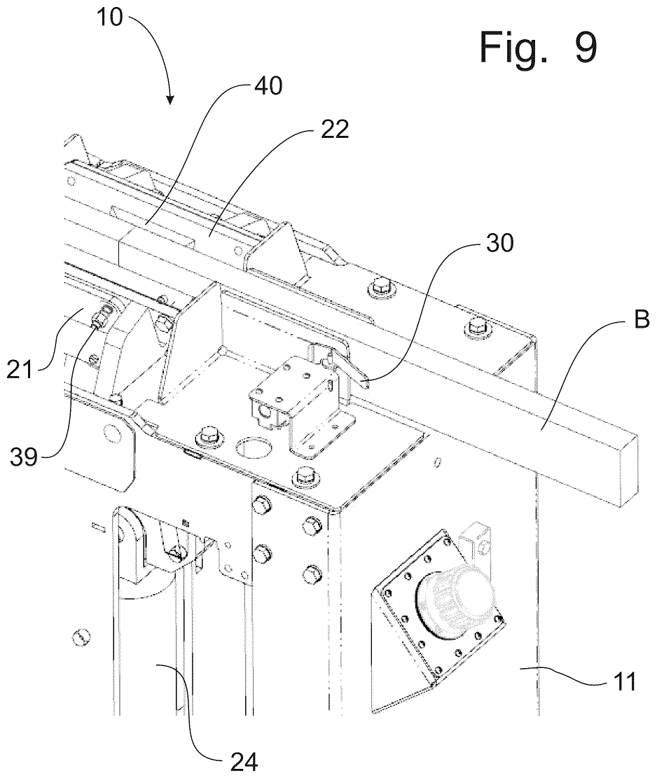

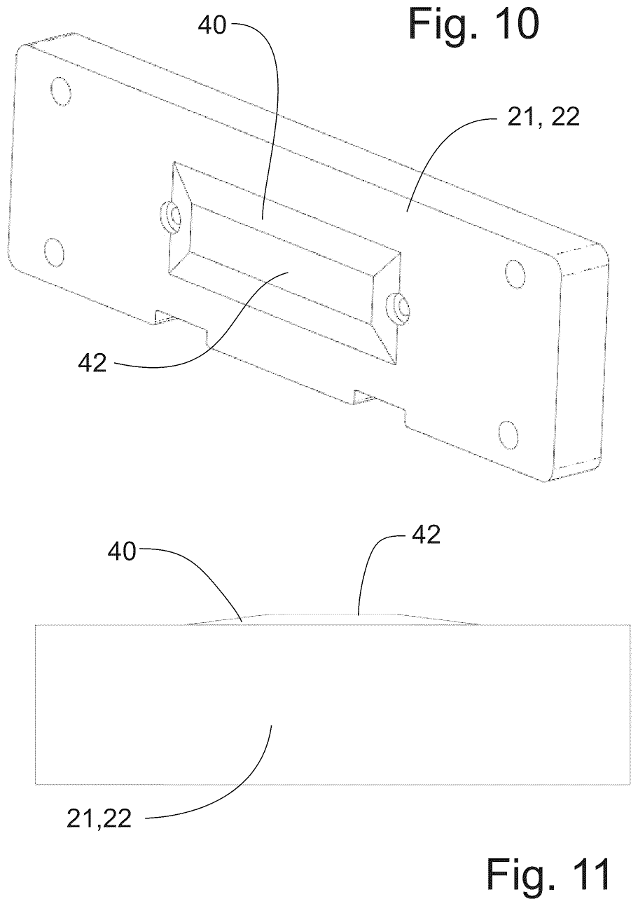

Referring to FIGS. 1-11, a splicing machine operable to splice together two lumber members with opposing nailer plates and incorporating the principles of the instant invention can best be seen. Rather than roll the nailer plates into the two lumber members or directly pushing the nailer plates into the two lumber members, the instant splicing machine pivots the engagement of the nailer plates into the two lumber members, as will be described in greater detail below. With the pivoting operation of the nailer plates into the lumber members, the lumber members can be supported in situ as the nailer plates are pressed into the bodies of the two lumber members. This configuration of a splicer machine is easily adapted to automation, as will also be described in greater detail below.

Referring now to FIGS. 1-3, the splicing machine 10 can best be seen. The splicing machine 10 is preferably formed as an upright stand-alone apparatus with a frame 11 and covering sheet metal 12. The top surface 13 of the splicing machine 10 has a tray 16 along which the two lumber members to be spliced together can be supported. The tray 16 includes a linear base member 16 on which the lumber members can be supported and moved linearly to position the lumber members for splicing, and two sets of vertical supports 17 that retain the lumber members in a vertical orientation for splicing. In situations where outboard support of the lumber members is necessary due to the length of the lumber members remote supports can be optionally provided to maintain the lumber members in a horizontal manner with a vertical orientation, i.e., for a 2×4 lumber member the nominal two inch dimension is horizontal and the approximate distance between the two vertical supports 17 of each set and the nominal four inch dimension is vertical, keeping in mind that a 2×4 dimensional lumber usually has dimensions of about 1.5 inches by 3.5 inches.

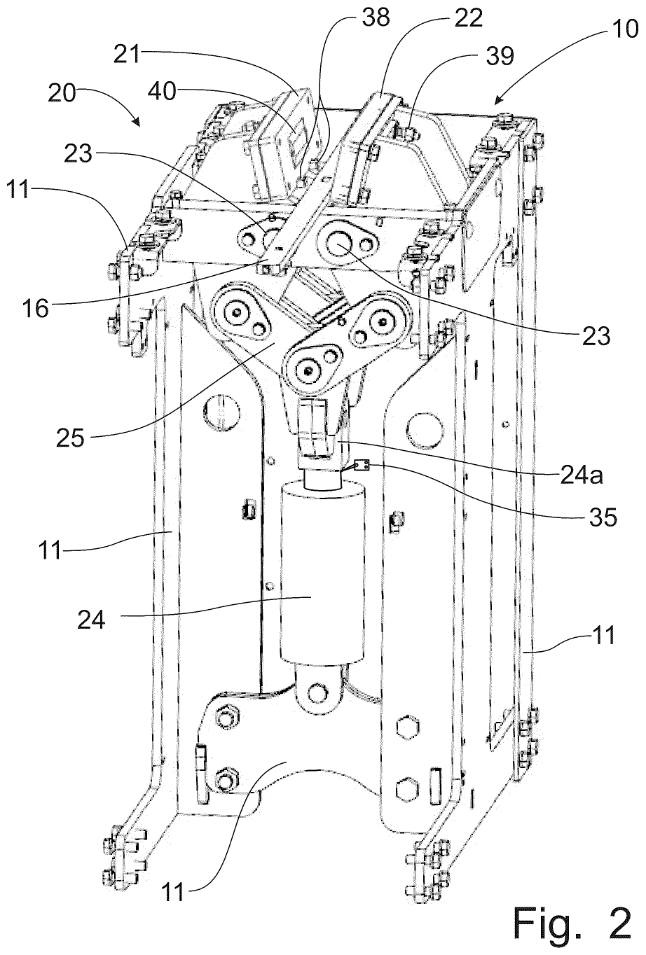

Referring now to FIGS. 2-4, the splicing operation is powered by a linear actuator 24 which is preferably a hydraulic cylinder but can also be a pneumatic cylinder or other known forms of a linear actuator. The linear actuator 24 is attached to the frame 11 to provide a base for powering movement of the splicing apparatus 20. Each of the movable jaws 21, 22 are pivotally connected to another portion of the frame 11 so as to be pivotally movable about a horizontally extending pivot axis 23 corresponding to the aligned pivots of the movable jaw members 21, 22. A linkage 25 interconnects the upper end of the extendable rod 24a of the linear actuator 24 and the opposing jaw members 21, 22 to transfer the linear movement of the extendable rod 24a to pivot the movable jaws 21, 22 about the respective pivot axes 23.

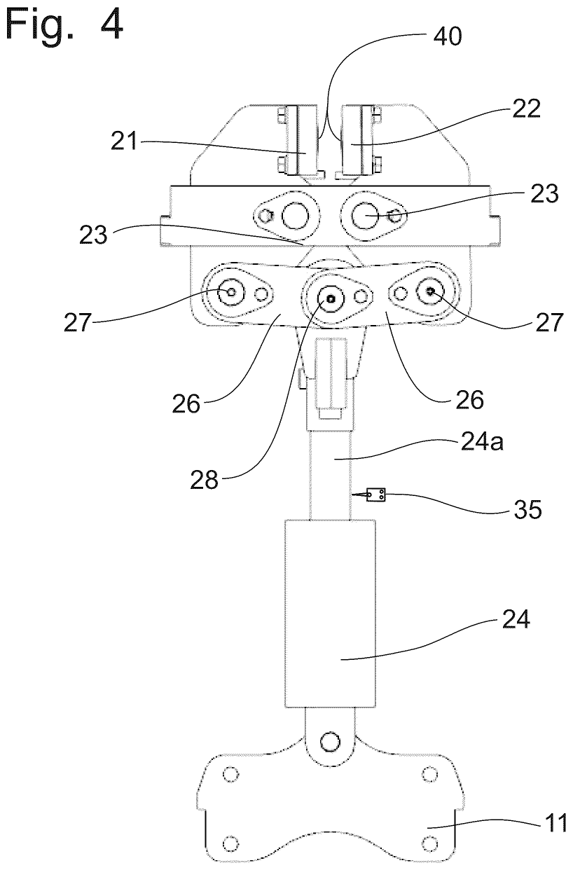

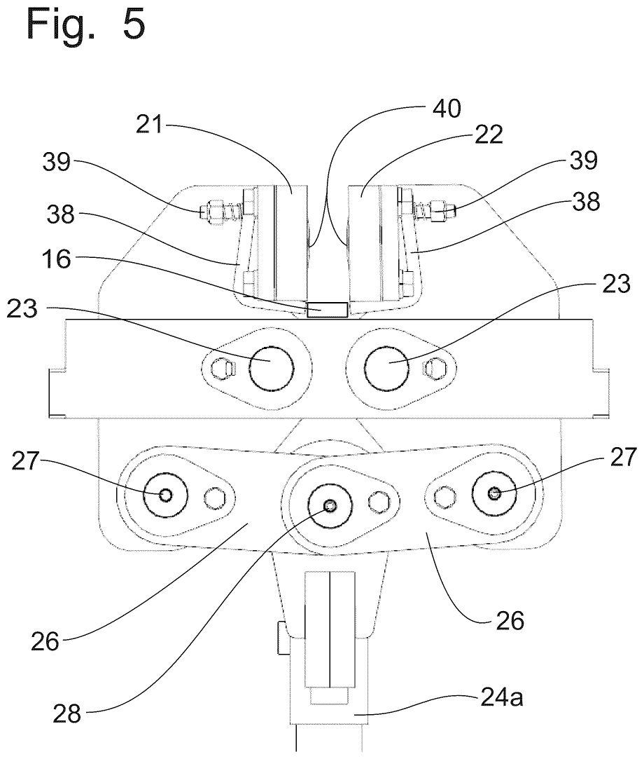

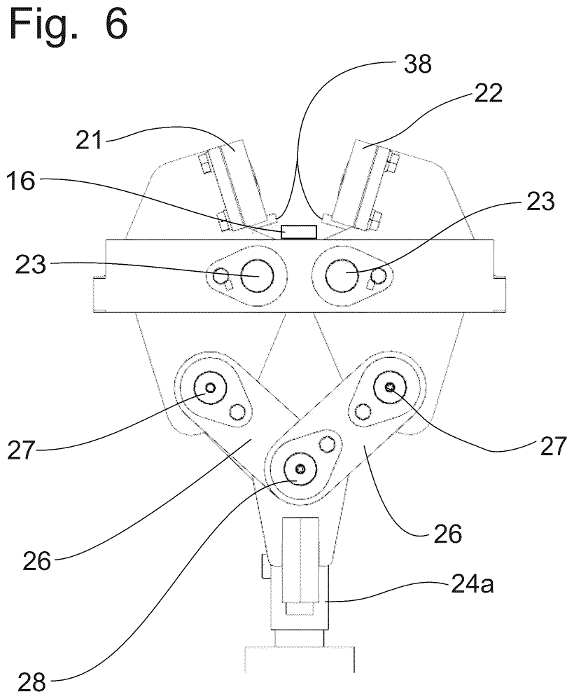

As best seen in FIGS. 4-6, the linkage 25 includes a pair of link members 26 that are both pivotally connected to the extendable rod 24a by a pivot 28. One link member 26 extends from the pivot 28 to a pivot 27 carried by the first jaw member 21, while the other link member 26 extends from the common pivot 28 to a pivot 27 carried by the second jaw member 22. In operation, the extension of the extendable rod 24a from the linear actuator 24 pushes the pivot 28 upwardly, as is depicted in FIGS. 4 and 5. The link members 26 then push the pivots 27 carried by the jaw members 21, 22 outwardly, affecting pivotal movement of the jaw members 21, 22 about the respective pivots 23 to pivot the jaw members 21, 22 toward each other into the closed position. As shown in FIG. 6, the retraction of the extendable member 24a pulls the pivot 28 downwardly, drawing the pivots 27 inwardly toward one another to affect pivotal movement of the jaw members 21, 22 away from one another into the opened position.

As is best seen in FIGS. 1 and 7-9, the splicing machine 10 is provided with a pair of spaced electric actuator levers 30, 32, incorporating switches (not shown) that control the movement of the linear actuator. Also, the splicing machine 10 has a safety switch 35 that is co-operable with the head of the extendable rod 24a to shut off the hydraulic system, thus preventing movement of the extendable rod 24a until the two actuator levers 30, 32 are selectively engaged by the operator. The electric actuator levers 30, 32 operate in a synchronized manner such that the linear actuator 24 will not operate to move the movable jaws 21, 22 into the closed position unless both actuator levers 30, 32 are depressed; however, should one of the actuator levers 30, 32 be released, or disengaged, while the other actuator lever 30, 32 is still engaged, the linear actuator 24 will cease moving, but not retract either.

The electric actuator levers 30, 32 are positioned on opposing sides of the movable jaw, members 21, 22 so that the operator's hands will be remotely positioned relative to the jaw members 21, 22 before the linear actuator 24 can be activated to move the jaw members 21, 22 from the opened position to the closed position. Once the nailer plates are installed, splicing the two lumber members together, the operator releases the two actuator levers 30, 32 and the rod 24a retracts into the linear actuator 24 until the head of the rod 24a engages the safety switch 35 which serves to shut off the system powering the operation of the linear actuator 24. One skilled in the art will note that the positioning of the actuator levers 30, 32 are located with respect to the operator behind the lumber members being spliced, which enables the operator to use the palms of his hand to press down on the respective lumber members as the operator reaches over the lumber members to manipulate the actuation levers 30, 32. This manual pressure on the top of the lumber members helps to keep the lumber members in a proper position against the tray 16 and abutting each other.

The result of this pivotal movement of the movable jaws 21, 22 is that the nailer plates are started at the bottom thereof into engagement with the lumber members as the continued progression of the engagement moving upwardly as the movable jaws 21, 22 move toward the closed position. The lumber members are not moving, and are not moved, as the nailer plates are engaging into the lumber members from the bottom to the top. Another advantage is that the initial engagement of the nailer plates with the bottom of the lumber member, and progressing toward the top of the lumber members, draws the lumber members downwardly against the base member 16 of the tray 16, thus keeping the lumber members together at the joint therebetween.

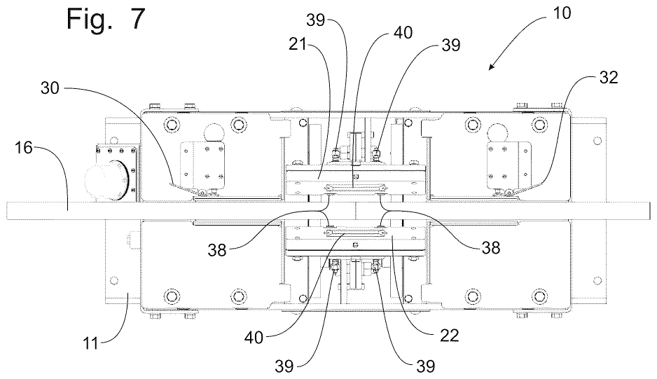

As best seen in FIGS. 7-11, each movable jaw 21, 22 has a bulge 40 at the center of the jaw 21, 22 so that the nailer plates are pressed into the lumber members at the seam between the lumber members being sliced together. Lumber members are well known for being slightly irregular in shape, particularly at the ends thereof. The bulges 40 project from the plane of the movable jaws 21, 22 that engage the nailer plates to press the nailer plates into the lumber members to assure full engagement of the nailer plates into each respective end of the lumber members. The bulge 40 is sloped at the top and bottom from the plane of the corresponding jaw to a plateau 42 of the bulge 40. The sloped portions allow the bulge to gradually increase, and decrease, pressure on the nailer plate, which the plateau assures full engagement of the central portion of the nailer plate into the ends of the lumber members.

As best seen in FIGS. 2, 6 and 10, each movable jaw 21, 22, includes a pair of spring-loaded support bars 38 that are positioned beneath the jaws 21, 22. The support bars 38 are loosely mounted on the back of each movable jaw 21, 22 by bolts 39 carrying springs 39 such that the bars 38 project inwardly below each respective movable jaw 21, 22. The purpose of the support bars 38 is to support the nailer plate for the jaws 21, 22 while the jaws 21, 22 are in the opened position. As the jaws 21, 22 are pivoted toward the closed position, the tips of the support bars 38 engage the opposing sides of the tray 16 to cause the support bars 38 to retract beneath the corresponding jaw 21, 22 as the lower part of the nailer plates engage the lumber members. The springs on the bolts 39 allow the support bars 38 to retract but assert a bias on the support bars 38 to cause the support bars 38 to project inwardly from each jaw 21, 22 when the jaws 21, 22 move back into the opened position.

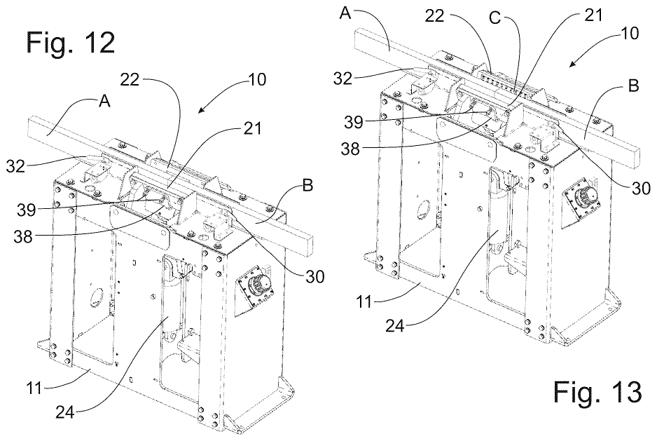

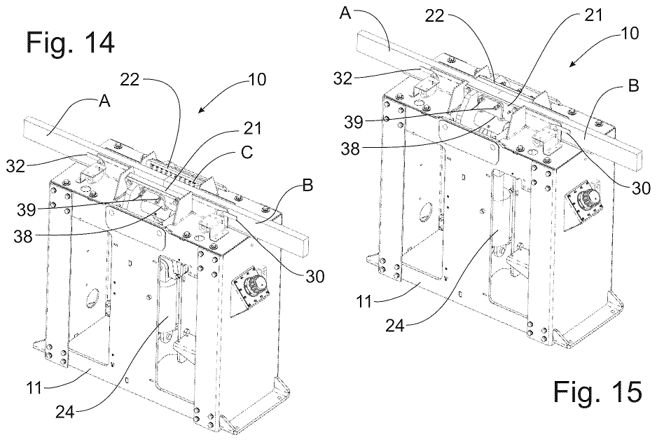

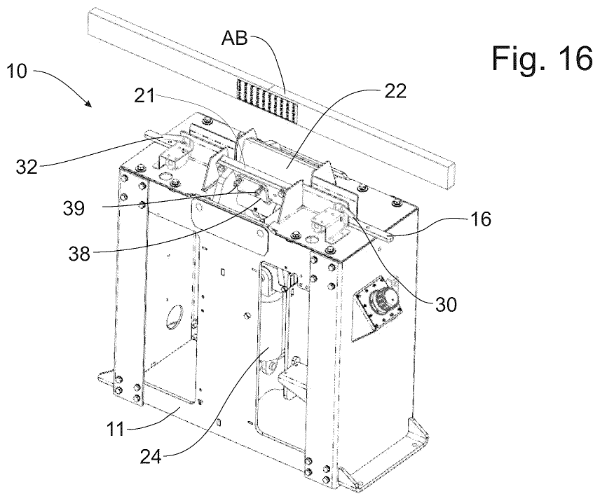

Referring now to FIGS. 12-16, the operation of the splicing machine 10 can best be seen. As is represented in FIG. 12, the operator (not shown) has manually placed two lumber members A, B on the tray 16 so that the two lumber members A, B are abutting one another at the center of jaw members 21, 22. In FIG. 13, the operator has positioned two nailer plates C (only one of which can be seen in the drawings) on the support bars 38 against the respective jaw members 21, 22. In FIG. 14, the operator has placed his hands on top of the lumber members A, B and reaches over with his fingers to depress the activation levers 30, 32 to power the linear actuator 24. In FIG. 15, the extendable rod 24a is extended to the position depicted in FIG. 5 and moves the movable jaw members 21, 22 into the closed position. This pivotal movement of the jaw members 21, 22 presses the nailer plates C into the lumber members A, B from the bottom up until the nailer plates C are fully inserted into the lumber members A, B. As shown in FIG. 16, the operator has released both activation levers 30, 32 to retract the movable rod 24a to the position depicted in FIG. 6 and move the jaw members 21, 22 into the opened position. The operator can then remove the spliced lumber member AB from the splicing machine for subsequent incorporation into a roof truss.

Automation of this splicer machine 10 could be accomplished in a reasonable manner. The lumber members A and B can be fed automatically onto the tray 16 by utilizing a feeding mechanism and appropriately located stop members (not shown) so that properly sized lumber members A, B can be properly positioned on the tray 16 for splicing. The nailer plates C can be fed automatically into position on the jaw members 21, 22 for insertion into the lumber members A. B. The movement of the jaw members 21, 22 into the opened position can activate a switch that powers the feeding mechanism to remove the spliced lumber member AB and direct two more lumber members into position on the for a sequential splicing operation.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiments of the invention; however, concepts, as based upon the description, may be employed in other embodiments without departing from the scope of the invention.

Having thus described the invention, what is claimed is:

1. A lumber splicing apparatus for joining two pieces of lumber to form a single larger piece of lumber, comprising:
a frame;
a support tray mounted on said frame to receive two pieces of lumber abutted against one another; and
a pair of movable jaws pivotally mounted on said frame, each movable jaw being operable to carry a nailer plate above said support tray for engagement with opposite sides of said lumber, each movable jaw causing a lower portion of the corresponding nailer plate to engage into a lower portion of the pieces of lumber and progressively move vertically into engagement with the pieces of lumber as the movable jaws move into a closed position to complete the installation of the nailer plates into the pieces of lumber.

2. The lumber splicing apparatus of claim 1 wherein each said movable jaw includes a pivot located below said support tray to cause each said movable jaw to engage a lower portion of the corresponding nailer plate into a lower portion of the pieces of lumber above said support tray and progressively move vertically into engagement with the pieces of lumber as the movable jaws move into the closed position.

3. The lumber splicing apparatus of claim 2 wherein each said movable jaw is coupled to a linear actuator by a pivot linkage to transfer linear movement of the actuator into pivotal movement of the movable jaws.

4. The lumber splicing apparatus of claim 1 wherein said movable jaws are powered in movement by a linear actuator coupled to a pair of actuation levers positioned on opposing sides of the movable jaws, said linear actuator being operable to affect movement of the movable jaws into a closed position when both of said actuation levers are depressed.

5. The lumber splicing apparatus of claim 4 wherein the release of one of said actuation levers causes said linear actuator to cease moving, while the release of both said actuation levers affects movement of said linear actuator to return said movable jaws to an opened position.

6. The lumber splicing apparatus of claim 5 further comprising a kill switch mounted for engagement with said linear actuator when said movable jaws are returned to said opened position to prevent said linear actuator from working until both said actuator levers are depressed.

7. A method of joining two pieces of lumber together to form a single larger piece of lumber, comprising the steps of:
providing a lumber splicing apparatus having a pair of vertically oriented movable jaws mounted to be movable between an opened position in which the vertically distal ends thereof a spaced at a greater distance than the corresponding lower ends, and a closed position in which the vertically distal ends and the lower ends are approximately equidistantly spaced;
positioning two pieces of lumber to be joined together on a support tray between said movable jaws while in said opened position;
mounting a nailer plate against each of the movable jaws; and
activating movement of said movable jaws from said opened position to said closed position, such that each said nailer plate is first engaged into a lower portion of said pieces of lumber and progressively engaged vertically into the pieces of lumber as the movable jaws move into said closed position.

8. The method of claim 7 wherein each said movable jaw is pivotally movable about a pivot located below said support tray when moving between said opened position and said closed position.

9. The method of claim 7 wherein said activating step includes affecting pivotal movement of said movable jaws by a linear actuator.

10. The method of claim 7 wherein said linear actuator is coupled to said movable jaws by a pivot linkage that permits a single actuator to move both movable jaws simultaneously.

11. The method of claim 7 wherein said activating step pulls the lumber being joined together downwardly against the support tray to maintain the positional relationship between the two pieces of lumber being joined together as the nailer plates are being installed.

12. The method of claim 9 wherein said mounting step includes the step of placing said nailer plates on support bars positioned below said movable jaws, said support bars being spring-loaded so as to retract beneath said movable jaws when said support bars engage said tray as said nailer plates are first engaging said lumber pieces.

13. An apparatus for splicing two lumber members together with a pair of nailer plates, comprising:
a frame;
a tray supported on said frame to receive said lumber members;
a pair of movable jaw members supported on said frame on opposing sides of said tray in a vertical orientation, said jaw members being pivotally movable between an opened position and a closed position;
a linear actuator mounted on said frame and being movable between a retracted position and an extended position; and
a linkage interconnecting said linear actuator and said jaw members to affect movement of said jaw members between said opened and closed positions in response to movement of said linear actuator between said retracted and extended positions.

14. The apparatus of claim 13 wherein the pivotal movement of said jaw members presses said nailer plates into said lumber members from a lower portion of the lumber members and progressing move vertically such as the movable jaws move into the closed position so that said nailer plates are fully inserted into said lumber members when said jaw members reach the closed position.

15. The apparatus of claim 14 wherein each said movable jaw includes a pivot located below said support tray to cause each said movable jaw to engage a lower portion of the corresponding nailer plate into a lower portion of the pieces of lumber above said support tray, each said movable jaw being coupled to said linear actuator by a pivot linkage to transfer linear movement of the actuator into pivotal movement of the movable jaws.

16. The apparatus of claim 13 wherein said movable jaws are powered in movement by said linear actuator, which is coupled to a pair of actuation levers positioned on opposing sides of the movable jaws, said linear actuator being operable to affect movement of the movable jaws into a closed position when both of said actuation levers are depressed.

17. The apparatus of claim 16 wherein the release of one of said actuation levers causes said linear actuator to cease moving, while the release of both said actuation levers affects movement of said linear actuator to return said movable jaws to an opened position.

18. The apparatus of claim 17 further comprising a kill switch mounted for engagement with said linear actuator when said movable jaws are returned to said opened position to prevent said linear actuator from working until both said actuator levers are depressed.

19. The apparatus of claim 13 further comprising a pair of support bars projecting toward said tray from beneath each of said movable jaws on which said nailer plates are positioned when said movable jaws are in said opened position, said support bars being spring-loaded to retract below said movable jaws when engaged into said tray as said movable jaws move from said opened position toward said closed position.

20. The apparatus of claim 19 wherein said spring-loaded support bars return to a position projecting toward said tray to receive said nailer plates when said movable jaws are returned to said opened position.
